(19) United States
(12) Patent Application Publication
(10) Pub. No.: US 2019/0190877 A1
(43) Pub. Date: Jun. 20, 2019

(54) INVERTED FAN-OUT FOR RELEVANT NOTIFICATION OF ACTIVITY

(71) Applicant: Microsoft Technology Licensing, LLC, Redmond, WA (US)

(72) Inventors: Jinyun Yan, Sunnyvale, CA (US); Yan Gao, Sunnyvale, CA (US); Viral Gupta, Sunnyvale, CA (US); Shaunak Chatterjee, Sunnyvale, CA (US); Shipeng Yu, Sunnyvale, CA (US); Romer E. Rosales-Delmoral, Burlingame, CA (US); Gaurav Chandalia, Fremont, CA (US)

(21) Appl. No.: 15/849,541

(22) Filed: Dec. 20, 2017

(51) Int. Cl. H04L 12/58; G06F 17/30; H04L 29/08

(52) U.S. Cl. CPC H04L 51/32; H04L 67/306; H04L 67/02; G06F 17/30867

(57) ABSTRACT

Techniques for reducing delay in broadcasting content over a network using an inverted fan-out process are disclosed herein. In some embodiments, a computer-implemented method comprises: in response to an activity associated with content being performed by a user on an online service, detecting that the activity has been performed: identifying a plurality of recipient users in response to the detecting; and for each one of the plurality of recipient users, transmitting a notification of the activity to a destination associated with the recipient user in response to the identifying of the recipient users, the notification comprising an indication of the content, and the transmitting of the notification of the activity being performed without waiting for the recipient user to navigate to a web page of the online service on a computing device or for the recipient to open a mobile application of the online service on a mobile device.

### TECHNICAL FIELD

The present application relates generally to the transmission of electronic messages and, in one specific example, to methods and systems of reducing delay in broadcasting content over a network using an inverted fan-out technique to notify the most relevant recipients of a user's online activity.

### BACKGROUND

For online services, delays in the delivery of content to users is a problem. In order to be provided the content the user has to navigate to a web page of the online service, open a mobile application of the online service, or wait for the online service to transmit content to the user. Even in situations in which the online service transmits content to the user, the transmission of the content is not performed immediately after the content is generated or published on the online service, but rather waits for a scheduled time, such that the content becomes stale and, therefore, irrelevant. Additionally, the transmission of such stale and irrelevant content consumes significant electronic resources involved in the generation of the transmission messages (e.g., wasting processing power), the transmission of the messages (e.g., wasting network bandwidth), and the storage of the messages in a memory associated with an account of the user (e.g., wasting database storage space).

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a broadcast system, in accordance with an example embodiment.

FIG. 4 illustrates a graphical user interface (GUI) in which a user can perform an activity associated with content on an online service, in accordance with an example embodiment.

FIG. 5 illustrates a ranking of candidate users, in accordance with an example embodiment.

FIG. 6 illustrates a notification of an activity, in accordance with an example embodiment.

FIG. 7 is a flowchart illustrating a method of reducing delay in broadcasting content over a network, in accordance with an example embodiment.

FIG. 8 is a flowchart illustrating a method identifying a plurality of recipient users, in accordance with an example embodiment.

FIG. 9 is a flowchart illustrating a method of transmitting a notification of an activity, in accordance with an example embodiment.

FIG. 10 is a flowchart illustrating another method of reducing delay in broadcasting content over a network, in accordance with an example embodiment.

FIG. 11 is a block, diagram illustrating a mobile device, in accordance with some example embodiments.

FIG. 12 is a block diagram of an example computer system on which methodologies described herein may be executed, in accordance with an example embodiment.

### DETAILED DESCRIPTION

Example methods and systems of reducing delay in broadcasting content over a network using an inverted fan-out technique to notify the most relevant recipients of a user's online activity are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. Some technical effects of the system and method of the present disclosure are to enable a computer system to reduce delay in broadcasting content over a network using an inverted fan-out technique. As a result, the consumption of electronic resources involved in the generation of the transmission messages (e.g., wasting processing power), the transmission of the messages (e.g., wasting network bandwidth), and the storage of the messages in a memory associated with an account of the user (e.g., wasting database storage space) may be reduced. Additionally, other technical effects will be apparent from this disclosure as well.

In some example embodiments, a computer system (or other machine) having a memory and at least one hardware processor, employs a methodology to identify the most relevant, or otherwise appropriate, recipients for a piece of content, and then transmitting the piece of content to those identified recipients. In some example embodiments, the computer system ranks users for a piece of content instead of ranking pieces of content for a user, thereby using an inverted fan-out process for broadcasting content. In some example embodiments, the computer system employs restrictions on transmitting notifications to a user in order to avoid excessive transmission of notifications to the user.

In some example embodiments, operations are performed by a computer system (or other machine) having a memory and at least one hardware processor, with the operations comprising: in response to an activity associated with content being performed by a user on an online service, detecting that the activity has been performed; identifying a plurality of recipient users in response to the detecting that, the activity has been performed, the identifying comprising: identifying a plurality of candidate users based on the plurality of candidate users being associated with the user in a database of the online service; ranking the plurality of candidate users using a model based on one or more of at least one attribute of the user, at least one attribute of each one of the plurality of candidate users, at least one attribute of the activity, and at least one attribute of the content; and selecting the a portion of the plurality of candidate users to be the plurality of recipient users based on the ranking; and for each one of the plurality of recipient users, transmitting a notification of the activity to a destination associated with the recipient user in response to the identifying of the plurality of recipient users, the notification comprising an indication of the content, and the transmitting of the notification of the activity being performed without waiting for the recipient user to navigate to a web page of the online service on a computing device or for the recipient to open a mobile application of the online service on a mobile device.

In some example embodiments, the activity comprises the user posting the content entered by the user on the online service, the user sharing the content submitted by another user on the online service, the user liking the content submitted by another user on the online service, the user commenting on the content submitted by another user on the online service, the user connecting with another user on the online service, or the user updating an aspect of a profile of the user on the online service.

In some example embodiments, the transmitting the notification comprises: selecting a template from a plurality of templates based on a type of the activity; and generating the notification using the selected template to format the notification.

In some example embodiments, the performing of the identifying the plurality of recipient users is conditioned upon a determination that the activity does not satisfy a filter criteria. In some example embodiments, the filter criteria comprising at least one of: the user being included in a list of users for which notifications of activities are not to be generated and transmitted; the content including a keyword that is included in a list of keywords for which notifications are not to be generated and transmitted, and the content has a format for which notifications are not to be generated and transmitted.

In some example embodiments, the operations further comprise: determining that a number of notifications that have been sent to a particular user of the online service within a predetermined period of time exceeds a threshold value, wherein the identifying the plurality of recipient users comprises omitting the particular user from the plurality of recipient users based on the determining that the number of notifications exceeds the threshold value.

In some example embodiments, the operations further comprise: determining that the activity is similar to another activity for which a notification was transmitted to a destination associated with a particular user within a predetermined period of time based on a comparison of the activity with the other activity, with the identifying the plurality of recipient users comprises omitting the particular user from the plurality of recipient users based on the determining that the activity is similar to the other activity.

In some example embodiments, the operations further comprise: determining that the content associated with the activity is similar to other content associated another activity for which, a notification was transmitted to a destination associated with a particular user within a predetermined period of time based on a comparison of the content associated with the activity with the other content associated with the other activity, with the identifying the plurality of recipient users comprises omitting the particular user from the plurality of recipient users based on the determining that the content is similar to the other content.

In some example embodiments, the model used for the ranking of the plurality of candidate users is based on a level of relevancy between the user and the candidate users. In some example embodiments, the model used for ranking the plurality of candidate users is based on how the candidate users have responded to notifications of other activities similar to the activity associated with the user. In some example embodiments, the model used for ranking the plurality of candidate users is based on how the candidate users have responded to notifications of other activities associated with content similar to the content associated with the activity associated with the user.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

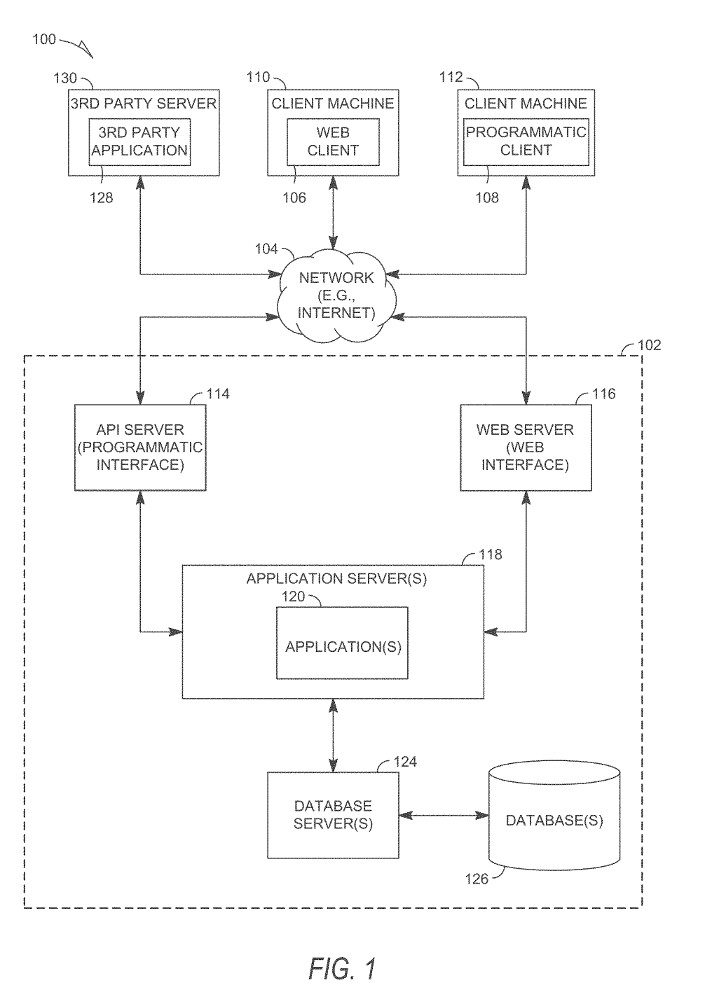

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support, one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API sender 114) may communicate with the mobile app and the application server(s) 118 in order to make the features of the present disclosure available on the mobile device.

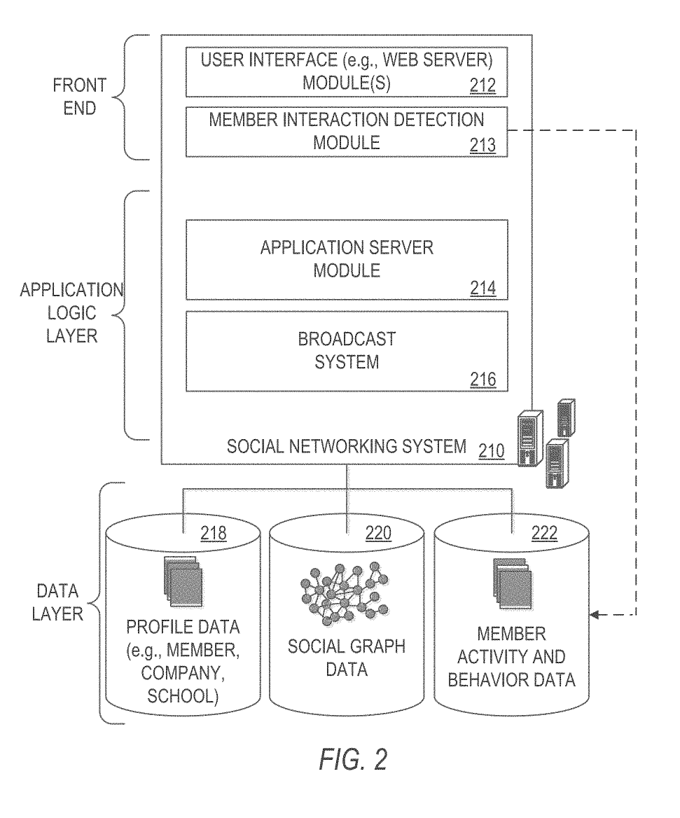

In some embodiments, the networked system 102 may comprise functional components of a social networking service. FIG. 2 is a block diagram showing the functional components of a social networking system 210, including a data processing module referred to herein as a broadcast system 216, for use in social networking system 210, consistent with some embodiments of the present disclosure. In some embodiments, the broadcast system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the broadcast system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the broadcast system 216.

In some embodiments, databases 218, 220, and 222 may be incorporated into database(s) 126 in FIG. 1. However, other configurations are also within, the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the broadcast system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

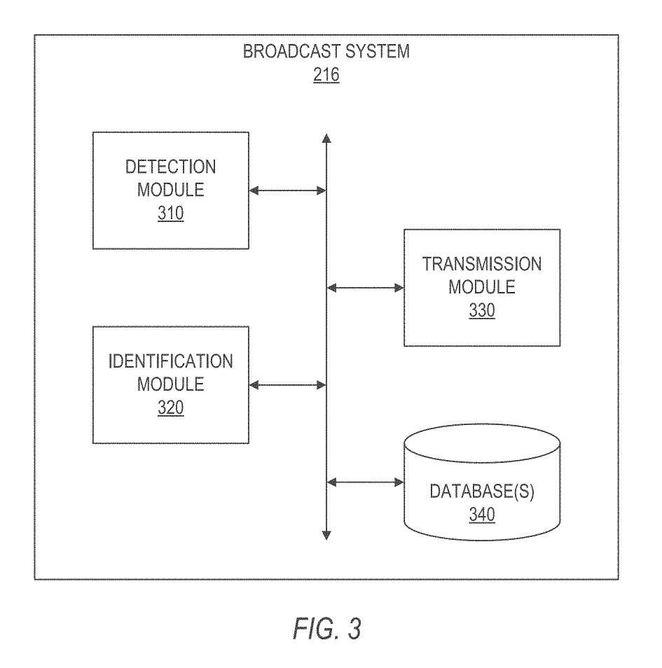

FIG. 3 is a block diagram illustrating components of the broadcast system 216, in accordance with an example embodiment. In some embodiments, the broadcast system 216 comprises any combination of one or more of a detection module 310, an identification module 320, a transmission module 330, and one or more database(s) 340. The modules 310, 320, and 330 and the database(s) 340 can reside on a computer system, or other machine, having a memory and at least one processor (not shown). In some embodiments, the modules 310, 320, and 330 and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the modules 310, 320, and 330, as well as the database(s) 340, are also within the scope of the present disclosure.

In some example embodiments, one or more of the modules 310, 320, and 330 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, and 330 is configured to receive user input. For example, one or more of the modules 310, 320, and 330 can present one or more GUI elements (e.g., drop-down menu, selectable buttons, text field) with which a user can submit input.

In some example embodiments, one or more of the modules 310, 320, and 330 is configured to perform various communication functions to facilitate the functionality described herein, such as by communicating with the social networking system 210 via the network 104 using a wired or wireless connection. Any combination of one or more of the modules 310, 320, and 330 may also provide various web services or functions, such as retrieving information from the third party servers 130 and the social networking system 210. Information retrieved by the any of the modules 310, 320, and 330 may include profile data corresponding to users and members of the social networking service of the social networking system 210.

Additionally, any combination of one or more of the modules 310, 320, and 330 can provide various data functionality, such as exchanging information with database(s) 340 or servers. For example, any of the modules 310, 320, and 330 can access member profiles that include profile data from the database(s) 340, as well as extract attributes and/or characteristics from the profile data of member profiles. Furthermore, the one or more of the modules 310, 320, and 330 can access social graph data and member activity and behavior data from database(s) 340, as well as exchange information with third party servers 130, client machines 110, 112, and other sources of information.

In some example embodiments, the detection module 310 is configured to detect that an activity associated with content has been performed by a user on an online service. The activity may comprise any action performed by the online service with respect to the content at the direction of the user, such as by the user clicking or tapping on a selectable user interface element configured to trigger the performance of the action by the online service. Such actions may include, but are not limited to, a publishing of content on the online service and a modification of data in one or more databases of the online service. In some example embodiments, the online service comprises a social networking service, such as the social networking system 210 in FIG. 2. However, other types of online services are also within the scope of the present disclosure.

In some example embodiments, the publishing of content on the online service comprises one or more of the user posting content entered by the user via the online service, the user sharing content submitted by the user or by another user via the online service, the user liking content submitted by another user via the online service, and the user commenting on content submitted by another user via the online service. It is contemplated that other embodiments of the publishing of content may also be recognized as the activity to be detected and are also within the scope of the present disclosure.

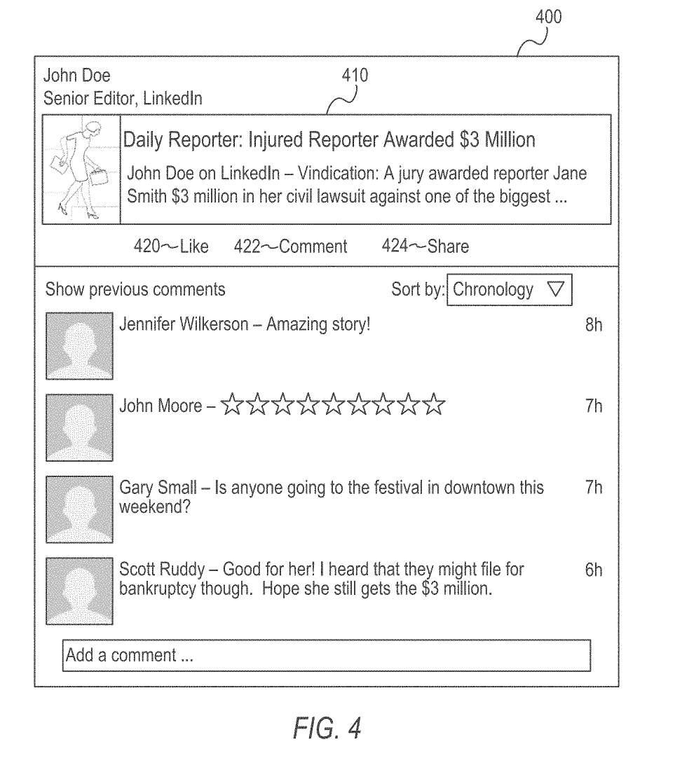

FIG. 4 illustrates a graphical user interface (GUI) 400 in which a user can perform an activity associated with content 410 on an online service, in accordance with an example embodiment. In FIG. 4, the content 410 comprises an article that has been published by another user. The GUI 400 displays selectable user interface elements 420, 422, and 424 each configured to trigger the performance of a corresponding action by the online service in response to their selection by the user. For example, the selectable user interface element 420 is configured to trigger the online service to recognize and publish the user's liking of the content 410, the selectable user interface element 422 is configured to enable the user to submit a comment associated with the content 410, thereby triggering the online service to recognize and publish the user's comment associated with the content 410, and the selectable user interface element 424 is configured to trigger the online service to recognize and publish the user's sharing of the content 410. Other types of selectable user interface elements and activities are also within the scope of the present disclosure.

In some example embodiments, the modification of data in one or more databases of the online service comprises one or more of the user connecting with another user on the online service, and the user updating an aspect of a profile of the user on the online service. Such modifications to data may comprise a modification of profile data in the database 218 in FIG. 2 or a modification of social graph data in the database 220 in FIG. 2. It is contemplated that other embodiments of a modification of data may also be recognize as the activity to be detected and are also within the scope of the present disclosure.

In some example embodiments, the detection module 310 is configured to detect that an activity has been performed in response to the activity being performed. In this respect, the detection module 310 immediately detects that the activity has been performed once the activity has been performed, rather than the detection module 310 waiting until the end of the day to collect information about activities that have been performed or waiting until a user accesses the online service (e.g., navigating to a web page of the online service or opening a mobile application of the online service).

In some example embodiments, the identification module 320 is configured to identify a plurality of recipient users based on the detecting that the activity has been performed. In some example embodiments, the identification module 320 is configured to identify the plurality of recipient users in response to the detecting that the activity has been performed, thereby immediately determining the recipient users to which notifications will be transmitted once the performance of the activity has been detected, rather than the identification module 320 waiting until the end of the day to identify the recipient users or waiting until a user accesses the online service (e.g., navigating to a web page of the online service or opening a mobile application of the online service).

In some example embodiments, the identification module 320 identifies the recipient users by identifying a plurality of candidate users based on the plurality of candidate users being associated with the activity-performing user in a database of the online service, ranking the identified candidate users, and selecting a portion of the candidate users to be the recipient users based on the ranking. The identifying of candidate users based on the candidate users being associated with the activity-performing user in the database of the online service may comprise identifying candidate users based on the candidate users being connected, or having some other type of association or relationship, to the user that is stored and maintained within a social graph of the online service, such as within a social graph stored in the database 220 in FIG. 2.

In some example embodiments, the identification module 320 is configured to rank the identified candidate users using a model. The model may be based on any combination of one or more of the user that performed the activity, the candidate users, the detected activity, and the content associated with the activity. In some example embodiments, one or more attributes of the user that performed the activity, the candidate users, the detected activity, and the content associated with the activity are used to rank the identified candidate users.

Attributes of the user that may be used in the ranking of the candidate users include, but are not limited to, any profile data, social graph data, or activity and behavior data of the user that is stored in the databases 218, 220, and 222 in FIG. 2. Attributes of the candidate users that may be used in the ranking of the candidate users include, but are not limited to, any profile data, social graph data, or activity and behavior data of the candidate users that is stored in the databases 218, 220, and 222 in FIG. 2. Attributes of the detected activity that may be used in the ranking of the candidate users include, but are not limited to, a type or classification, of the detected activity (e.g., a “like” versus a “comment” versus a “share”), a time at which the detected activity is performed, a geographic location from which the detected activity was instructed by the user (e.g., where was the user located when the user shared the content), and a type of device from which the user instructed the performance of the detected activity (e.g., from a srnartphone versus from a desktop computer versus from a tablet computer). Attributes of the content associated with the detected activity that may be used in the ranking of the candidate users include, but are not limited to, a format of the content, a category of the content, one or more words in the content, one or more images in the content, and a time at which, the content was authored or published on the online service.

In some example embodiments, the identification module 320 generates relevancy values for the candidate users based on an analysis of one or more of the attributes discussed above. The model can be used to determine the relevancy value for each candidate user, and then to rank the candidate users based on their corresponding relevancy values.

In some example embodiments, the model used for the ranking of the plurality of candidate users generates the relevancy value of a candidate user based on a level of relevancy between the user and the candidate user. For example, the identification module 320 may compare one or more attributes (e.g., profile data) of the candidate user with one or more attributes (e.g., profile data) of the user to determine the level of similarity between the two users, and, therefore, the level of relevancy between the two users.

In some example embodiments, the model used for the ranking of the plurality of candidate users generates the relevancy value of a candidate user based on how the candidate users have responded to notifications of other activities similar to the activity associated with or performed by the user, how the candidate users have responded to notifications of other activities associated with content similar to the content associated with the activity associated with or performed by the user, and/or how the candidate users have responded to notifications of other activities associated with content similar to the content associated with the activity associated with or performed by the user. For example, if the detected activity comprises a liking of an article by the user, the identification module 320 may, for each candidate user, determine how many times the candidate user has been presented with a notification of any user liking content any user liking any article, any user liking a similar article, the same user liking content, the same user liking any article, and/or the same user liking a similar article, and then determined how often the candidate selected to view more information about the activity or content, of the notification in response to the notification, such as by selecting a selectable link included in the notification. In some example embodiments, the identification module 320 increases the relevancy value of a candidate user the more responsive the candidate user has been to similar notification, similar activities, similar content, and/or similar users that are associated with or that performed the activity.

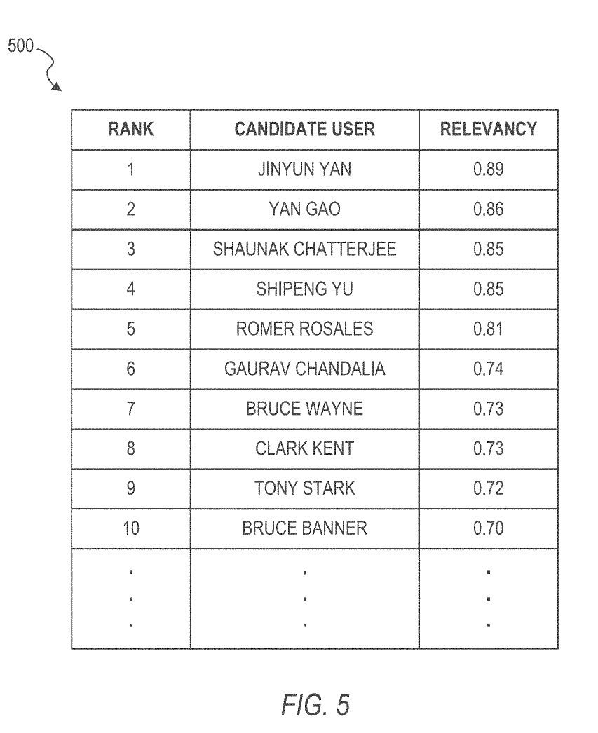

FIG. 5 illustrates a ranking 500 of candidate users, in accordance with an example embodiment. The ranking 500 shows the candidate users (JINYUN YAN, YAN GAO, SHAUNAK CHATTERJEE, etc. in FIG. 5) ranked in order of their corresponding relevancy values (0.89, 0.86, 0.85, etc. in FIG. 5). In some example embodiments, the identification module 320 selects a portion of the candidate users to be the recipient users based on the ranking, such as by selecting the top N ranked candidate users to be the recipient users, where N is an integer or a percentage. For example, in FIG. 5, the identification module 320 may select the top seven ranked candidate users from the ranking 500 (from JUNYUN YAN to BRUCE WAYNE in ranking 500) to be the recipient users.

In some example embodiments, the identification module 320 is configured to omit a particular user from the plurality of recipient users based on certain criteria to avoid excessive notifications being transmitted, or otherwise presented, to the particular user. One example of such criteria is a determination that the total number of notifications that have been transmitted, or otherwise presented, to the particular user within a predetermined period of time (e.g., within the last 24 hours, within the last week, etc.) exceeds a threshold value. Another example of such criteria is a determination that the activity is the same or similar to another activity for which a notification was transmitted to a destination associated with the particular user (e.g., to an e-mail account of the particular user, to a mobile application on a mobile device of the particular user) within a predetermined period of time based on a comparison of the activity with the other activity, in order to avoid notifications of the same or similar activity being sent to the particular user too frequently (e.g., in order to prevent too many notifications of “likes” from being presented to the particular user within a specific period of time). Yet another example of such criteria is a determination that the content associated with the activity is similar to other content associated with another activity for which a notification was transmitted to a destination associated with, the particular user within a predetermined period of time based on a comparison of the content associated with the activity with the other content associated with the other activity, in order to avoid notifications involving the same or similar content being sent to the particular user too frequently (e.g., in order to prevent too many notifications of any type involving the same article or articles about similar content from being presented to the particular user within a specific period of time).

In some example embodiments, the identification module 320 is configured to filter out certain detected activities from having corresponding notifications generated or transmitted, and/or from having recipient users identified for the generation and transmission of corresponding notifications. The identification module 320 may filter out detected activities based on a determination that the detected activities satisfy a filter criteria. For example, in some example embodiments, the identification module 320 is configured to condition the performance of the identifying of the plurality of recipient, users upon a determination that the detected activity does not satisfy a filter criteria. In some example embodiments, the filter criteria comprises any combination of one or more of the user associated with the activity being included in a list of users for which notifications of activities are not to be generated and transmitted (e.g., a blacklist of users that are associated with spam or other inappropriate activities or content), the content associated with the activity including a keyword that is included in a list of keywords for which notifications are not to be generated and transmitted, and the content has a format for which notifications are not to be generated and transmitted. Other types of filter criteria are also within the scope of the present disclosure.

In some example embodiments, the transmission module 330 is configured to, for each one of the plurality of recipient users, transmit a notification of the activity to a destination, associated with the recipient user based on the identifying of the plurality of recipient users. In some example embodiments, the transmission module 330 is configured to, for each one of the plurality of recipient users, transmit a notification of the activity to a destination associated with the recipient user in response to the identifying of the plurality of recipient users, thereby immediately transmitting the notifications to the identified recipient users once the recipient users have been identified, rather than the transmission module 330 waiting until the end of the day to transmit the notifications or waiting until a user accesses the online service (e.g., navigating to a web page of the online service or opening a mobile application of the online service).

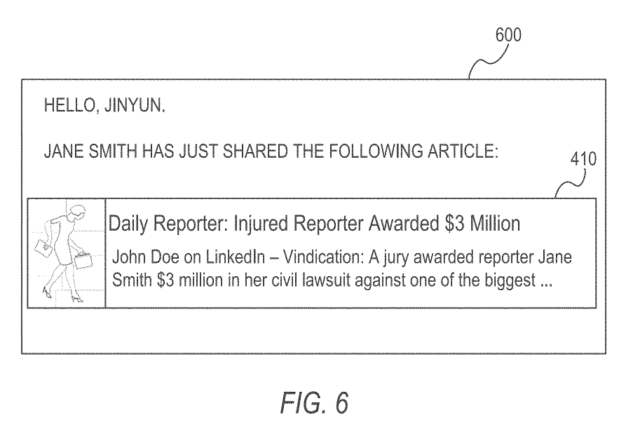

In some example embodiments, the notification comprises an indication of the content associated with the detected activity. FIG. 6 illustrates a notification 600 of an activity, in accordance with an example embodiment. As seen in FIG. 6, the notification 600 includes an indication of the content 410 on which the detected activity was directed. For example, the notification 600 may include an indication of an article for which Jane Smith selected the selectable user interface element 424 for sharing the article in FIG. 4. In some example embodiments, the indication of the content 410 comprises a portion of the content 410 or the entirety of the content 410. In some example embodiments, the indication of the content 410 may comprises a link to the entirety of the content, such as a link to an article that is shared. It is contemplated that other types of notifications are also within the scope of the present disclosure.

In some example embodiments, the transmitting of the notification of the activity is performed by the transmission module 330 without waiting for the recipient user to navigate to a web page of the online service on a computing device or for the recipient to open a mobile application of the online service on a mobile device. In this respect, the transmission module 330 minimizes any delay in broadcasting the notification, preventing the notification from being stale or otherwise irrelevant to the recipient user. In some example embodiments, the performance of an activity associated with, content by the user triggers a chain reaction in which the activity is detected, recipient users are identified, and notifications are transmitted to the recipient users in real-time or near real-time, thereby improving the efficiency of the computer system of the online service.

In some example embodiments, the transmission module 330 is configured to selecting a template from a plurality of templates based on a type of the activity, and then generate the notification for the activity using the selected template to format the notification. For example, the online service may store the plurality of templates in the database(s) 340, with a different template being stored for each one of a plurality of different activity types, such as one template for notifications of likes, another template for notifications of comments, yet another template for notifications of shares, and so on and so forth. The transmission module 330 may determine the type of activity to which the detected activity corresponds, then select the template corresponding to that determined type of activity, and then user that selected template to generate the notification of the detected activity, inputting data that is specific to the user, the recipient user, and/or the content associated with, the detected activity into the template to form the notification. By using these templates to generate the notifications, the transmission system 330 can generate and transmit notifications faster and more efficiently. Other ways of generating the notifications of the detected activities are also within the scope of the present disclosure.

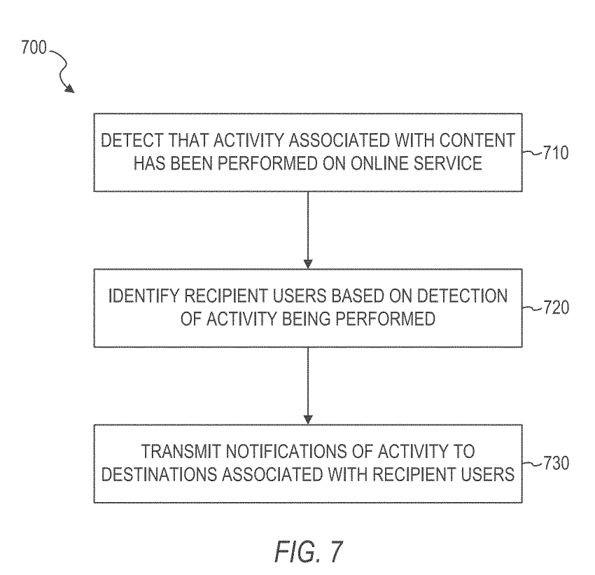

FIG. 7 is a flowchart, illustrating a method 700 of reducing delay in broadcasting content over a network, in accordance with an example embodiment. Method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the broadcast system 216 of FIGS. 2-3, or any combination of one or more of its modules, as described above.

At operation 710, the broadcast system 216, in response to, or otherwise based on, an activity associated with content being performed by a user on an online service, detects that the activity has been performed. In some example embodiments, the online service comprises a social networking service. However, other types of online services are within the scope of the present disclosure. In some example embodiments, the activity comprises the user posting the content entered by the user on the online service, the user sharing the content submitted by another user on the online service, the user liking the content submitted by another user on the online service, the user commenting on the content submitted by another user on the online service, the user connecting with another user on the online service, or the user updating an aspect of a profile of the user on the online service. However, other types of activities are also within the scope of the present disclosure.

At operation 720, the broadcast system 216 identifies a plurality of recipient users in response to, or otherwise based on, the detecting that the activity has been performed. In some example embodiments, the broadcast system 216 determines that a number of notifications that have been sent to a particular user of the online service within a predetermined period of time exceeds a threshold value, and the identifying the plurality of recipient users comprises omitting the particular user from the plurality of recipient users based on the determining that, the number of notifications exceeds the threshold value. In some example embodiments, the broadcasts system 216 determines that the activity is similar to another activity for which a notification was transmitted to a destination associated with a particular user within a predetermined period of time based on a comparison of the activity with the other activity, and the identifying the plurality of recipient, users comprises omitting the particular user from the plurality of recipient users based on the determining that the activity is similar to the other activity. In some example embodiments, the broadcast system 216 determines that the content associated with the activity is similar to other content associated another activity for which a notification was transmitted to a destination associated with a particular user within a predetermined period of time based on a comparison of the content associated with the activity with the other content associated with the other activity, and the identifying the plurality of recipient users comprises omitting the particular user from the plurality of recipient users based on the determining that the content is similar to the other content.

At operation 730, the broadcast system 216, for each one of the plurality of recipient users, transmits a notification of the activity to a destination associated with the recipient user in response to, or otherwise based on, the identifying of the plurality of recipient users. In some example embodiments, the notification comprises an indication of the content. In some example embodiments, the transmitting of the notification of the activity is performed without waiting for the recipient user to navigate to a web page of the online service on a computing device or for the recipient to open a mobile application of the online service on a mobile device.

It is contemplated that any of the other features described within the present disclosure can be incorporated into method 700.

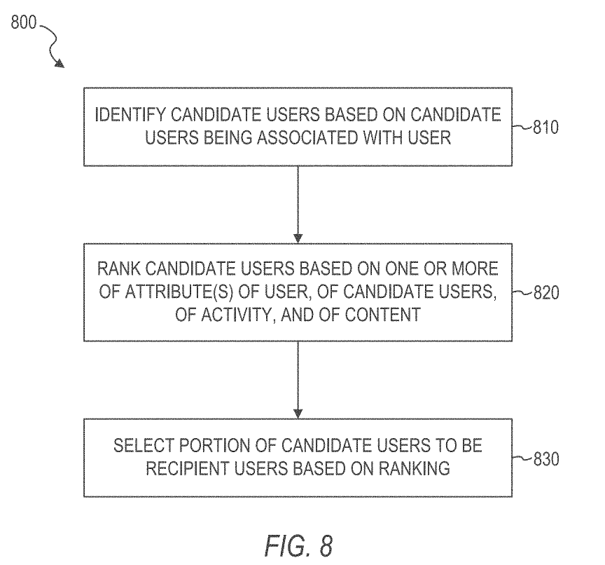

FIG. 8 is a flowchart, illustrating a method 800 identifying a plurality of recipient users, in accordance with an example embodiment. Method 800 can be performed by processing logic that can comprise hardware (e.g., circuitry, dedicated logic, programmable logic, microcode, etc.), software (e.g., instructions am on a processing device), or a combination thereof. In one implementation, the method 800 is performed by the broadcast system 216 of FIGS. 2-3, or any combination of one or more of its modules, as described above.

At operation 810, the broadcast system 216 identifies a plurality of candidate users based on the plurality of candidate users being associated with the user in a database of the online service. At operation 820, the broadcast system 216 ranks the plurality of candidate users using a model based on one or more of at least one attribute of the user, at least one attribute of each one of the plurality of candidate users, at least one attribute of the activity, and at least one attribute of the content. In some example embodiments, the model used for the ranking of the plurality of candidate users is based on a level of relevancy between the user and the candidate users. In some example embodiments, the model used for ranking the plurality of candidate users is based, on how the candidate users have responded to notifications of other activities similar to the activity associated with the user. In some example embodiments, the model used for ranking the plurality of candidate users is based on how the candidate users have responded to notifications of other activities associated with content similar to the content associated with the activity associated with the user. At operation 830, the broadcast system 216 selects a portion of the plurality of candidate users to be the plurality of recipient, users based on the ranking.

It is contemplated that any of the other features described within the present disclosure can be incorporated into method 800.

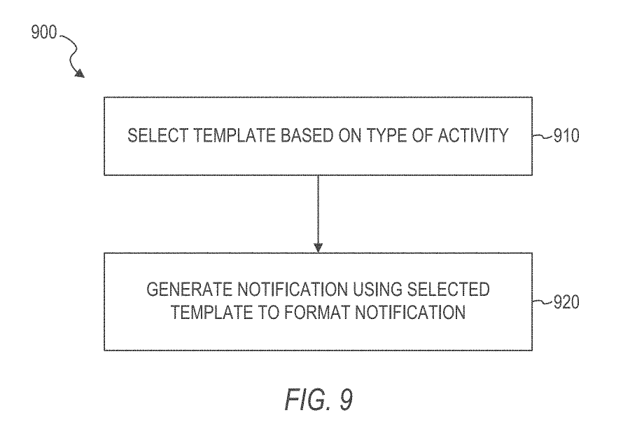

FIG. 9 is a flowchart illustrating a method 900 of transmitting a notification of an activity, in accordance with an example embodiment. Method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the broadcast system 216 of FIGS. 2-3, or any combination of one or more of its modules, as described above.

At operation 910, the broadcast system 216 selects a template from a plurality of templates based on a type of the activity. At operation 920, the broadcast system 216 generates the notification using the selected template to format the notification.

It is contemplated that any of the other features described within the present disclosure can be incorporated into method 900.

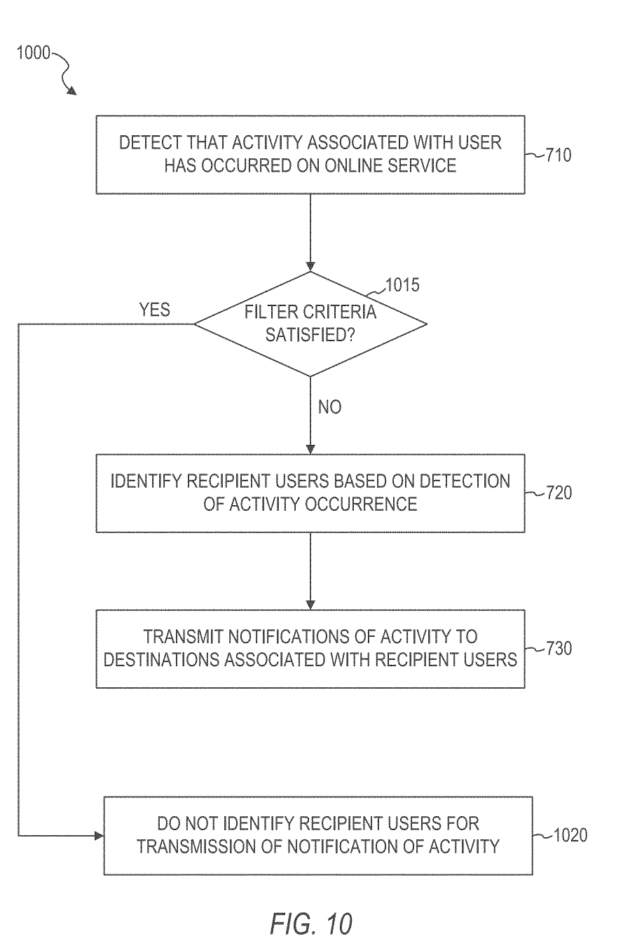

FIG. 10 is a flowchart illustrating another method 1000 of reducing delay in broadcasting content over a network, in accordance with an example embodiment. Method 1000 can be performed by processing logic that can comprise hardware (e.g., circuitry, dedicated logic, programmable logic, microcode, etc.), software (e.g., instructions run on a processing device), or a combination thereof. In one implementation, the method 1000 is performed by the broadcast system 216 of FIGS. 2-3, or any combination of one or more of its modules, as described above.

Method 1000 includes the operations of method 700, but incorporates the use of a filter criteria. In some example embodiments, the performing of the identifying the plurality of recipient users, at operation 720, is conditioned upon a determination that the activity does not satisfy a filter criteria. After an activity is detected by the broadcast system 216 at operation 710, the broadcasts system 216 determines, at operation 1015, whether or not a filter criteria is satisfied by one or more aspects associated with the activity. In some example embodiments, the filter criteria comprises at least one of: the user being included in a list, of users for which notifications of activities are not to be generated and transmitted, the content including a keyword that is included in a list of keywords for which notifications are not to be generated and transmitted, and the content has a format for which notifications are not to be generated and transmitted. If it is determined, at operation 1015, that the activity does not satisfy the filter criteria, then the broadcast system does not filter out the detected activity, and proceeds to operation 720, where the broadcasts system 216 identified the recipient users. If it is determined, at operation 1015, that the activity satisfies the filter criteria, then the broadcast system filters out the detected activity from having a notification generated and transmitted, proceeding to operation 1020, where the broadcasts system 216 does not identify recipient users for transmission of a notification of the detected activity.

It is contemplated that any of the other features described within the present disclosure can be incorporated into method 1000.

Although the examples disclosed herein refer to the use of an e-mail address and the conformation of an e-mail address, in some example embodiments, the features and operations of the present disclosure are additionally or alternatively applied to other types of contact information, including, but not limited to a destination for receiving text messages (e.g., a cell phone number).

### Example Mobile Device

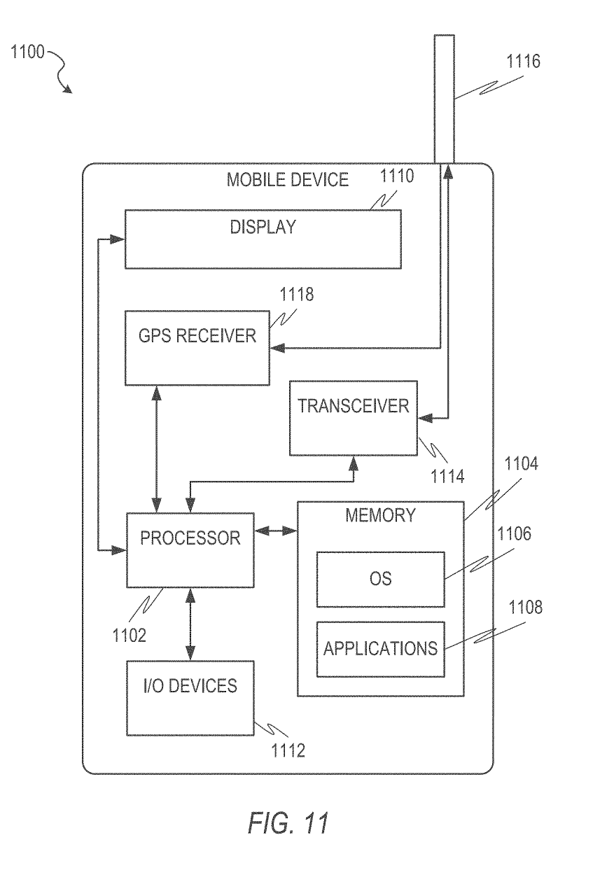

FIG. 11 is a block diagram illustrating a mobile device 1100, according to an example embodiment. The mobile device 1100 can include a processor 1102. The processor 1102 can be any of a variety of different types of commercially available processors suitable for mobile devices 1100 (for example, an XScale architecture microprocessor, a Microprocessor without Interlocked Pipeline Stages (MIPS) architecture processor, or another type of processor). A memory 1104, such as a random access memory (RAM), a Flash memory, or other type of memory, is typically accessible to the processor 1102. The memory 1104 can be adapted to store an operating system (OS) 1106, as well as application programs 1108, such as a mobile location-enabled application that can provide location-based services (LBSs) to a user. The processor 1102 can be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 can be coupled to a transceiver 1114 that interfaces with an antenna 1116. The transceiver 1114 can be configured to both transmit and receive cellular network signals, wireless data signals, or other types of signals via the antenna 1116, depending on the nature of the mobile device 1100. Further, in some configurations, a GPS receiver 1118 can also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to winch it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least, some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may he a design choice. Below are set out hardware (e.g., machine) and software architectures that may be deployed, in various example embodiments.

### Example Machine Architecture and Machine-Readable Medium

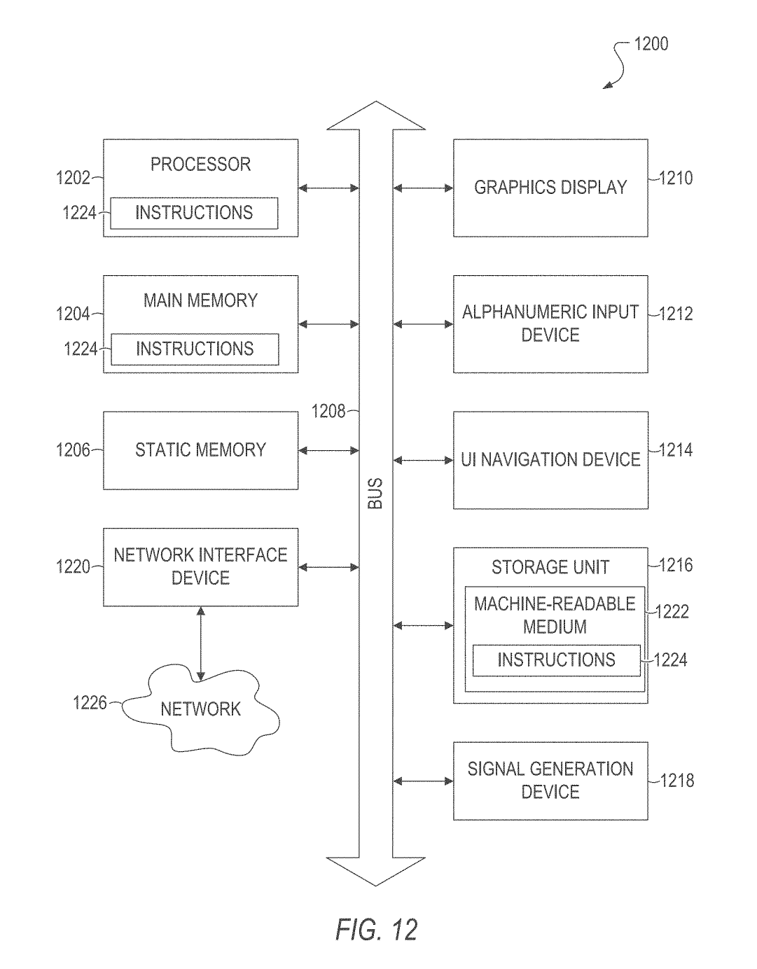

FIG. 12 is a block diagram of an example computer system 1200 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a graphics display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a storage unit 1216, a signal generation device 1218 (e.g., a speaker) and a network interface device 1220.

### Machine-Readable Medium

The storage unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions (e.g., instructions 1224) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited, to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
in response to an activity associated with content being performed by a user on an online service, detecting, by a computer system having at least one hardware processor, that the activity has been performed;
identifying, by the computer system, a plurality of recipient users in response to the detecting that the activity has been performed, the identifying comprising:
identifying a plurality of candidate users based on the plurality of candidate users being associated with the user in a database of the online service;
ranking the plurality of candidate users using a model based on one or more of at least one attribute of the user, at least one attribute of each one of the plurality of candidate users, at least one attribute of the activity, and at least one attribute of the content; and
selecting the a portion of the plurality of candidate users to be the plurality of recipient users based on the ranking; and
for each one of the plurality of recipient users, transmitting, by the computer system, a notification of the activity to a destination associated with the recipient user in response to the identifying of the plurality of recipient users, the notification comprising an indication of the content, and the transmitting of the notification of the activity being performed without waiting for the recipient user to navigate to a web page of the online service on a computing device or for the recipient to open a mobile application of the online service on a mobile device.

2. The computer-implemented method of claim 1, wherein the activity comprises the user posting the content entered by the user on the online service, the user sharing the content submitted by another user on the online service, the user liking the content submitted by another user on the online service, the user commenting on the content submitted by another user on the online service, the user connecting with another user on the online service, or the user updating an aspect of a profile of the user on the online service.

3. The computer-implemented method of claim 1, wherein the transmitting the notification comprises:
selecting a template from a plurality of templates based on a type of the activity; and
generating the notification using the selected template to format the notification.

4. The computer-implemented method of claim 1, wherein the performing of the identifying the plurality of recipient users is conditioned upon a determination that the activity does not satisfy a filter criteria, the filter criteria comprising at least one of:
the user being included in a list of users for which notifications of activities are not to be generated and transmitted,
the content including a keyword that is included in a list of keywords for which notifications are not to be generated and transmitted; and the content has a format for which notifications are not to be generated and transmitted.

5. The computer-implemented method of claim 1, further comprising:
determining that a number of notifications that have been sent, to a particular user of the online service within a predetermined period of time exceeds a threshold value, wherein the identifying the plurality of recipient users comprises omitting the particular user from the plurality of recipient users based on the determining that the number of notifications exceeds the threshold value.

6. The computer-implemented method of claim 1, further comprising:
determining that the activity is similar to another activity for which a notification was transmitted to a destination associated with a particular user within a predetermined period of time based on a comparison of the activity with the other activity, wherein the identifying the plurality of recipient users comprises omitting the particular user from the plurality of recipient users based on the determining that the activity is similar to the other activity.

7. The computer-implemented method of claim 1, further comprising:
determining that the content associated with the activity is similar to other content associated another activity for which a notification was transmitted to a destination associated with a particular user within a predetermined period of time based on a comparison of the content-associated with the activity with the other content associated with the other activity, wherein the identifying the plurality of recipient users comprises omitting the particular user from the plurality of recipient, users based on the determining that the content is similar to the other content.

8. The computer-implemented, method of claim 1, wherein the model used for the ranking of the plurality of candidate users is based on a level of relevancy between the user and the candidate users, the level of relevancy being based on a comparison of the at least one attribute of the user with the at least one attribute of the candidate users to determine a level of similarity between the user and. the candidate users.

9. The computer-implemented method of claim 1, wherein the model used for ranking the plurality of candidate users is based on how the candidate users have responded to notifications of other activities similar to the activity associated with the user.

10. The computer-implemented method of claim 1, wherein the model used for ranking the plurality of candidate users is based on how the candidate users have responded to notifications of other activities associated with content similar to the content associated with the activity associated with the user.

11. A system comprising:
at least one hardware processor; and
a non-transitory machine-readable medium embodying a set of instructions that, when executed by the at least one hardware processor, cause the at least, one processor to perform operations, the operations comprising:
in response to an activity associated with content being performed by a user on an online service, detecting that the activity has been performed;
identifying a plurality of recipient users in response to the detecting that the activity has been performed, the identifying comprising:
identifying a plurality of candidate users based on the plurality of candidate users being associated with the user in a database of the online service;
ranking the plurality of candidate users using a model based on one or more of at least one attribute of the user, at least one attribute of each one of the plurality of candidate users, at least one attribute of the activity, and at least one attribute of the content; and
selecting the a portion of the plurality of candidate users to be the plurality of recipient users based on the ranking; and
for each one of the plurality of recipient users, transmitting a notification of the activity to a destination associated with the recipient user in response to the identifying of the plurality of recipient users, the notification comprising an indication of the content, and the transmitting of the notification of the activity being performed without waiting for the recipient user to navigate to a web page of the online service on a computing device or for the recipient to open a mobile application of the online service on a mobile device.

12. The system of claim 11, wherein the activity comprises the user posting the content entered by the user on the online service, the user sharing the content, submitted by another user on the online service, the user liking the content submitted by another user on the online service, the user commenting on the content submitted by another user on the online service, the user connecting with another user on the online service, or the user updating an aspect, of a profile of the user on the online service.

13. The system of claim 11, wherein the performing of the identifying the plurality of recipient users is conditioned upon a determination that the activity does not satisfy a filter criteria, the filter criteria comprising at least one of:
the user being included in a list of users for which notifications of activities are not to be generated and transmitted:
the content including a keyword that is included in a list of keywords for which notifications are not to be generated and transmitted; and
the content has a format for which notifications are not to be generated and transmitted.

14. The system of claim 11, wherein the operations further comprise:
determining that a number of notifications that have been sent to a particular user of the online service within a predetermined period of time exceeds a threshold value, wherein the identifying the plurality of recipient users comprises omitting the particular user from the plurality of recipient users based on the determining that the number of notifications exceeds the threshold value.

15. The system of claim 11, wherein the operations further comprise:
determining that the activity is similar to another activity for which a notification was transmitted to a destination associated with a particular user within a predetermined period of time based on a comparison of the activity with the other activity, wherein the identifying the plurality of recipient users comprises omitting the particular user from the plurality of recipient users based on the determining that the activity is similar to the other activity.

16. The system of claim 11, wherein the operations further comprise:
determining that the content associated with the activity is similar to other content associated another activity for which a notification was transmitted to a destination associated with a particular user within a predetermined period of time based on a comparison of the content associated with the activity with the other content associated with the other activity, wherein the identifying the plurality of recipient users comprises omitting the particular user from the plurality of recipient users based on the determining that the content is similar to the other content.

17. The system of claim 11, wherein the model used for the ranking of the plurality of candidate users is based on a level of relevancy between the user and the candidate users, the level of relevancy being based on a comparison of the at least one attribute of the user with the at least one attribute of the candidate users to determine a level of similarity between the user and the candidate users.

18. The system of claim 11, wherein the model used for ranking the plurality of candidate users is based on how the candidate users have responded to notifications of other activities similar to the activity associated with the user.

19. The system of claim 11, wherein the model used for ranking the plurality of candidate users is based on how the candidate users have responded to notifications of other activities associated with content similar to the content associated with the activity associated with the user.

20. A non-transitory machine-readable medium embodying a set of instructions that, when executed by at least one hardware processor, cause the processor to perform operations, the operations comprising:
in response to an activity associated with content being performed by a user on an online service, detecting that the activity has been performed:
identifying a plurality of recipient users in response to the detecting that the activity has been performed, the identifying comprising:
identifying a plurality of candidate users based on the plurality of candidate users being associated with the user in a database of the online service;
ranking the plurality of candidate users using a model based on one or more of at least one attribute of the user, at least one attribute of each one of the plurality of candidate users, at least one attribute of the activity, and at least one attribute of the content; and
selecting the a portion of the plurality of candidate users to be the plurality of recipient users based on the ranking; and
for each one of the plurality of recipient users, transmitting a notification of the activity to a destination associated with the recipient user in response to the identifying of the plurality of recipient users, the notification comprising an indication of the content, and the transmitting of the notification of the activity being performed without waiting for the recipient user to navigate to a web page of the online service on a computing device or for the recipient to open a mobile application of the online service on a mobile device.
